(19) United States
(12) Patent Application Publication
(10) Pub. No.: US 2005/0128922 A1
(43) Pub. Date: Jun. 16, 2005

(54) Image scanning and storage system and method thereof

(75) Inventor: Hyun Kim, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/006,780

(22) Filed: Dec. 8, 2004

(30) Foreign Application Priority Data
Dec. 11, 2003 (KR) 2003-90112

(51) Int. Cl. G11B 7/00; G11B 7/135; G02B 26/08

(52) U.S. Cl. 369/112.09

(57) ABSTRACT

An image scanning and storage system includes an image scanning apparatus, a peripheral device connected to the image scanning apparatus and a member for setting a scanning area. The image scanning apparatus has a scanning unit, a host controller and a control unit. The scanning unit scans an object in order to digitize an image of the object, and the host controller communicates with a medium. The control unit controls the scanning unit and the host controller to transmit the image scanned in the scanning unit to the medium through the host controller. The peripheral device has a display member, a memory, a device controller and a control member. The display member displays the image, and the memory store the image. The device controller communicates with the host controller. The control member displays the image pre-scanned in the image scanning apparatus on the display member and stores the scanned image in the memory according to a command signal of the control unit provided through the device controller. The member for setting a scanning area in the pre-scanned image displayed on the display member is installed either in the image scanning apparatus or in the peripheral device.

### PRIORITY

This application claims the benefit under 35 U.S.C. § 119(a) of Korean Patent Application No. 2003-90112, filed on Dec. 11, 2003, the entire content of which is incorporated herein by reference.

### BACKGROUND OF THE INVENTION

1. Field of the Invention

The present invention relates to an image scanning and storage system and a method thereof. More particularly, the present invention relates to an image scanning and storage system and a method thereof for storing an image which is formed by an image scanning apparatus in a peripheral device such as a digital camera without using a large system e.g., a computer.

2. Description of the Related Art

Image scanning apparatuses convert documents, pictures, or films, into digital data that will be stored in computers. The image scanning apparatuses also convert pictures and documents into graphic files and computer readable characters respectively using suitable software. The image scanning apparatuses include scanners, multi-function devices, digital copying machines and facsimiles. The conventional image scanning apparatus will be described below with respect to a scanner.

During an operation of a scanner, light is irradiated onto an object and an amount of light reflected from the object is measured. A voltage proportional to the amount of reflected light is applied to a circuit built in the scanner. The voltage applied to the circuit is then converted into certain pixel patterns. In short, the scanner projects an image by measuring the amount of reflected light.

Scanners are typically classified as hand scanners, sheet feed scanners and flat bed scanners depending upon an operation process. For the hand scanner, a user holds a device for moving the scanner over an object to be scanned. For the sheet feed scanner, a paper is inserted into an upper portion of the scanner, and the paper is scanned while moving downward as in an ink-jet printer. In the most widely used scanner which is the flat bed scanner, an object to be scanned is placed on a glass plate, and a scanning module scans the object while moving from the lower portion to the upper portion of the glass plate.

In order to set a pictorial image area of the object in the scanner, a gray scanning process and a color scanning process may be used.

Generally, during the gray scanning process, data in a green channel is used in a charge coupled device (CCD), and a green light source is used in a contact image sensor (CIS) to scan the object. In other words, only a green (G) light source is used among red (R), green (G) and blue (B) light sources in an image sensor such as CCD or CIS, thereby reducing a scanning time. When a pictorial image of the object has a complementary color of green, however, a blank area other than the pictorial image area may be generated depending on the gray data. Hence, some data may be lost, and the pictorial image area may not be properly set.

During the color scanning process, for example in multifunction machines, the image sensor such as CCD or CIS uses all of the red (R), green (G) and blue (B) light sources to scan the object. Thus, loss of data may not occur unlike the gray scanning process when the pictorial image has a complementary color of green. The scanning time, however, is relatively long.

In the gray scanning and color scanning processes, the overall area of the object is scanned with a constant dot per inch (DPI) to generate reference data and to determine a critical value for setting the pictorial image area. An algorithm is applied, which determines the area having values smaller than the critical value to be the pictorial image area, and determines a continuous area having values greater than the critical value to be the blank area. Accordingly, a large amount of reference data and a high capacity memory are required to process the data.

Recently, as office automation machines, for example printers, scanners and facsimiles, produce high quality images, manufacturing costs thereof have increased to affect product costs. Certain space is also required to install those machines. As a result, multifunction machines having most functions of the automation machines have emerged.

A multifunction machine generally has a printing member, a scanning member and an information transmitting member such as a modem. Thus, the multifunction machine serves as a printer, facsimile, scanner and copy machine. The multifunction machine has a personal computer interface function for connecting to a personal computer.

A computer interfaced with the multifunction machine generally includes a scanner driver that performs PC scan. The scanner driver controls the scanning member in the multifunction machine, i.e. scanner, to scan an object set in the multifunction machine. The scanner driver also receives the scanned image data to display the image data in an application program of the computer.

In order to perform the PC scan by operating the scanner driver, a user has to sequentially operate the application program and the scanner driver in the application program.

In the conventional method of operating the scanner driver, the multifunction machine is operated according to the computer operation. Thus, the scanning process may not be performed when the scanner is not connected to the computer. Conducting the scanning process is possible only when the computer is available. In addition, the user has to sequentially operate the application program and the scanner driver to perform the PC scan, which is inconvenient.

### SUMMARY OF THE INVENTION

Accordingly, the present invention is provided to substantially obviate one or more problems due to limitations and disadvantages of the related art.

The present invention provides an image scanning and storage system including an image scanning apparatus, a peripheral device connected to the image scanning apparatus and a member for setting a scanning area. The image scanning apparatus has a scanning unit, a host controller and a control unit. The scanning unit scans an object in order to digitize an image of the object, and the host controller communicates with a medium. The control unit controls the scanning unit and the host controller to transmit the image scanned in the scanning unit to the medium through the host controller. The peripheral device has a display member, a memory, a device controller and a control member. The display member displays the image, and the memory stores the image. The device controller communicates with the host controller. The control member displays the image pre-scanned in the image scanning apparatus on the display member and stores the scanned image in the memory according to a command signal of the control unit provided through the device controller. The member for setting a scanning area in the pre-scanned image displayed on the display member is installed either in the image scanning apparatus or in the peripheral device.

The peripheral device includes a digital camera, a personal digital assistant (PDA), a cellular phone or a digital camcorder.

The memory corresponds to an external memory that is removable from the peripheral device.

The member for setting includes a zoom key and a direction key. The zoom key zooms in or zooms out the image displayed in the display member. The direction key movies the image into up, down, right and left directions.

The image scanning apparatus comprises one of a scanner, a multi-function unit, a digital copying machine, and a facsimile.

The control member is programmed to provide the image scanning apparatus with information on the scanning area set by the zoom key and the direction key.

The communicating is performed using wireless or wireline communication process including USB, RS-232C, IrDA or Bluetooth interfaces.

According to one aspect of the present invention, an image scan and storage method is provided for an image scanning apparatus having a scanning unit, and a peripheral device connected to the image scanning apparatus via a communication port and having a display unit for the display of an image. The image scan and storage method include scanning an image in the image scanning apparatus; transmitting the scanned image to the peripheral device; and storing the scanned image to the memory of the peripheral device.

The present invention also provides a method of scanning and storing an image using an image scanning apparatus and a peripheral device connected to the image scanning apparatus through a communication port. The image scanning apparatus has a scanning unit for scanning the image, and the peripheral device has a display member for displaying the image. The image is pre-scanned in the image scanning apparatus. The pre-scanned image is primarily transmitted to the peripheral device. The transmitted pre-scanned image is displayed on the display member of the peripheral device. A scanning area is set in the pre-scanned image displayed on the display member. The set area is scanned in the image scanning apparatus. The scanned image is secondarily transmitted to the peripheral device. The scanned image is stored in a memory of the peripheral device.

The transmission steps are performed using USB, RS-232C, IrDA or Bluetooth.

The scanning area is set using a zoom key and a direction key installed either in the image scanning apparatus or in the peripheral device. The zoom key zooms in or zooms out the image, and the direction key moves the image into up, down, right and left directions.

When the zoom key and the direction key are installed in the peripheral device, information on the scanning area is transmitted from the peripheral device to the image scanning apparatus after setting the scanning area.

### BRIEF DESCRIPTION OF THE DRAWINGS

The above aspects and features of the present invention will be more apparent by describing certain embodiments of the present invention with reference to the accompanying drawings, in which:

FIG. 1 is a schematic perspective view illustrating an image scanning and storage system according to an exemplary embodiment of the present invention;

FIG. 2 is a block diagram illustrating the image scanning and storage system of FIG. 1;

FIG. 3 is a rear view of the digital camera of FIG. 1 having a pre-scanned image;

FIG. 4 is a rear view of the digital camera of FIG. 1 showing a scanning area of the pre-scanned image shown in FIG. 3; and

FIG. 5 is a flow chart illustrating an image scanning and storage method according to an exemplary embodiment of the present invention.

Throughout the drawings, it should be noted that the same or similar elements are denoted by like reference numerals.

### DETAILED DESCRIPTION OF THE PREFERRED EMBODIMENTS

Embodiments of the present invention will now be described in greater detail with reference to the accompanying drawings.

In an image scanning and storage system and a method using the same, an image scanning apparatus is connected to a peripheral device under an interface condition. An image pre-scanned in the image scanning apparatus is displayed on a display member of the peripheral device to set a scanning area. The scanning area is scanned again, and the scanned image is transmitted to the peripheral device to be stored. The scanning process and storage process are conducted using the peripheral device without computers.

Meanwhile, the image scanning apparatus generally operates to scan documents, pictures and films and convert the scanned data into digital data which can be stored in the computer. The image scanning apparatuses mainly include scanners, multi-function units, digital copying machines and facsimiles. Although the flat bed image scanning apparatus is solely described in the following embodiments, the image scanning and storage system and the method thereof according to embodiments of the present invention may also be employed in the sheet feed image scanning apparatus and the flat bed image scanning apparatus.

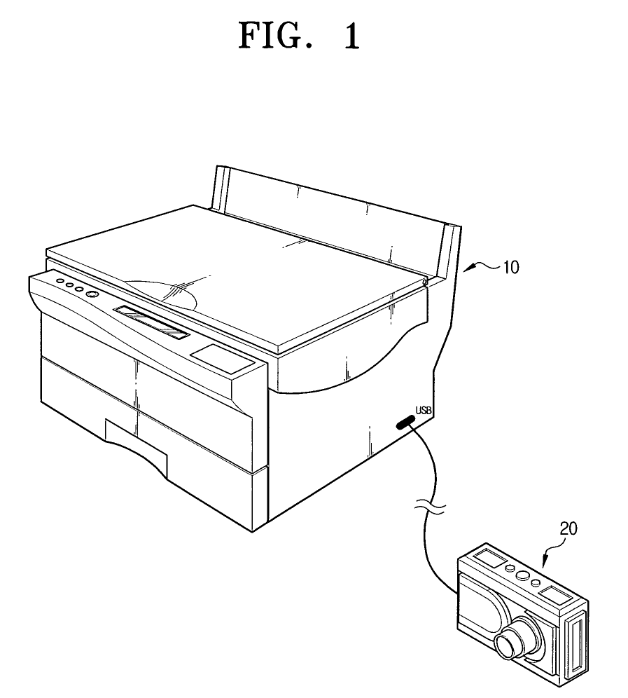

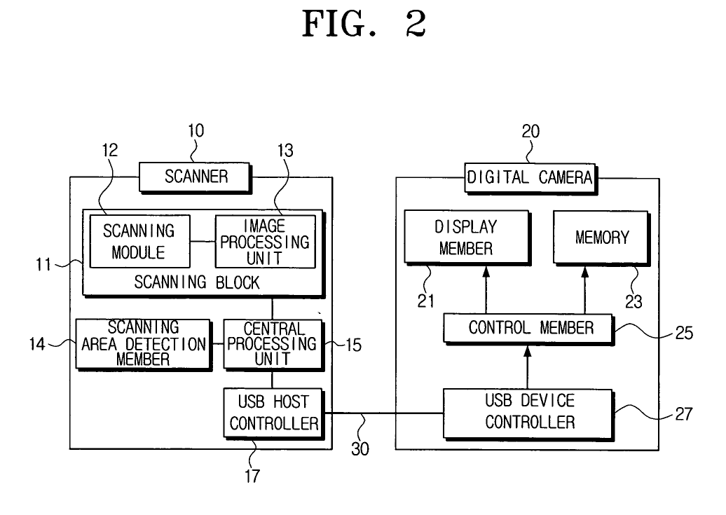

FIG. 1 is a schematic perspective view illustrating an image scanning and storage system according to an exemplary embodiment of the present invention. FIG. 2 is a block diagram illustrating the image scanning and storage system of FIG. 1.

Referring to FIGS. 1 to 2, the image scanning and storage system includes an image scanning apparatus 10, a digital camera 20 and a Universal Serial Bus (USB) cable 30. The image scanning apparatus 10 scans an image, and the digital camera 20 serves as a peripheral device that displays and stores a scanned image. The image scan apparatus 10 communicates with the digital camera 20 through the USB cable 30.

The image scanning apparatus 10 has a scanning unit 11, a USB host controller 17 and a control unit 15. The scanning unit 11 projects an image of an object. The USB host controller 17 provides the peripheral device with the scanned image and controls a USB device controller 27 in the peripheral device. The control unit 15 controls the overall operation of the image scanning apparatus 10.

The scanning unit 11 typically has a scanning module 12 that scans the object and an image processing unit 13 that processes the scanned image.

The scanning module 12 includes a Charge Coupled Device (CCD) image sensor, a lens and a light source. A carriage return motor drives the scanning module 12. The CCD image sensor has a photoelectric conversion part, a charge transmitting part and a signal detection part. The photoelectric conversion part absorbs light reflected from the object among the light irradiated onto the object to generate electrons. The charge transmitting part transmits the charge generated in the photoelectric conversion part to the signal detection part. The signal detection part detects the charge of the signal and converts information on the image supplied to the photoelectric conversion part into electrical signals.

The image processing unit 13 performs shading, a gamma correction, dot per inch (DPI) conversion, edge emphasis, error diffusion, etc. on the pictorial image data input from the scanning module 12.

As described in this embodiment, when a computer is connected to the peripheral device or a terminal using a USB method in order to comprise a network, the computer is used as a host, and the peripheral device or the terminal is used as a device. The USB host may be referred to as the USB host controller 17 in terms of hardware. The USB host controller 17 controls software, data flow and drivers needed for peripheral devices connected to a bus.

The USB host controller 17 is usually installed in a central unit such as a computer. In this embodiment, however, the USB host controller 17 is installed in the image scanning apparatus 10. The USB host controller 17 controls the USB device controller 27 of the digital camera 20 while transmitting the image scanned in the scanning unit 11 to the digital camera 20. Accordingly, a pre-scanned image is displayed on a display member 21 of the digital camera 20. After a scanning process is completed, the scanned image is stored in a memory 23 of the digital camera 20.

A zoom key 18 and a direction key 19 may be installed on one side face of the image scanning apparatus 10. The zoom key 18 and the direction key 19 are employed to select the scanning area in the pre-scanned image displayed on the display member 21 of the digital camera 20. The zoom key 18 zooms in or out of an image. The direction key 19 moves the image into up, down, right and left directions to display the area to be scanned on the display member 21. In order to detect the area selected by the zoom key 18 and the direction key 19, the image scanning apparatus 10 has a scanning area detection member 14.

Any terminal that has a display member 21 where the image scanned in the image scanning apparatus 10 is displayed and can interface with the image scanning apparatus 10 using a communication port may be used as the peripheral device connected to the image scanning apparatus 10. For example, an image recording device such as a digital camera or a digital camcorder, and a communication terminal such as a cellular phone or a personal digital assistant (PDA) may be used.

In this embodiment, as the peripheral device, the digital camera 20 is employed. The digital camera 20 includes the display member 21, the memory 23, the USB device controller 27 and a control member 25. The display member 21 displays the image provided from the image scanning apparatus 10, and the memory 23 stores the image. The USB device controller 27 is controlled by the USB host controller 17. The control member 25 controls the overall operation of the digital camera 20. The digital camera 20 may have various accessories for image sensing, but detailed explanations thereof irrelevant to the present invention will be omitted.

Examples of the display member 21 include a super twisted nematic liquid crystal display (STN-LCD) device, a thin film transistor liquid crystal display (TFT-LCD) device having clear and bright image quality, an ultra fine and brightness liquid crystal display (UFB-LCD) device developed by Samsung Electronics, Co. Ltd., and a thin film diode liquid crystal display (TFD-LCD) device developed by Seiko Epson Corporation, Japan. The TFT-LCD is the most widely used. The display member 21 disposed on a rear face of the digital camera 20 displays the image pre-scanned in the image scanning apparatus 10.

A removable external memory such as a memory stick or a memory card is commonly used as the memory 23. The memory 23 stores an image wave sensed at the digital camera 20 and the image after the scanning process is completed.

The USB device controller 27 connected to the digital camera 20 receives a command signal from the USB host controller 17 in the image scanning apparatus 10 and transmits the signal to the control member 25. When the image pre-scanned in the image scanning apparatus 10 is transmitted to the digital camera 20 through the USB cable 30, the USB device controller 27 provides the command signal to the control member 25. The control member 25 then controls the digital camera 20 in order to display the pre-scanned image on the display member 21. When the image after the scanning process is completed is transmitted to the digital camera 20, the USB device controller 27 transmits the command signal again to the control member 25, and the control member 25 stores the transmitted image in the memory 23.

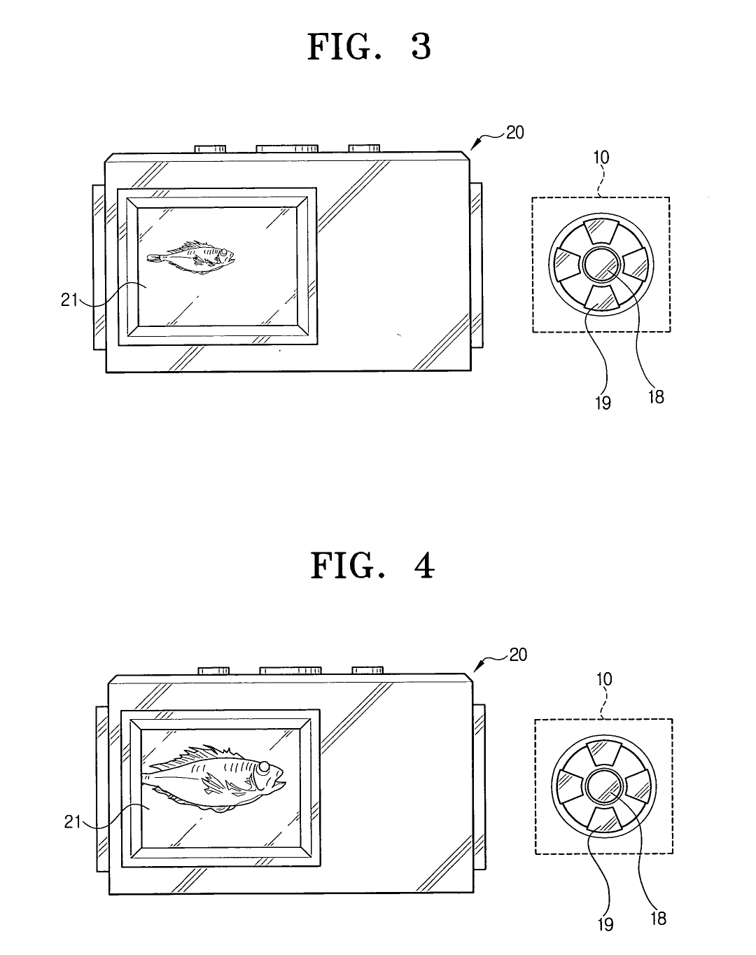

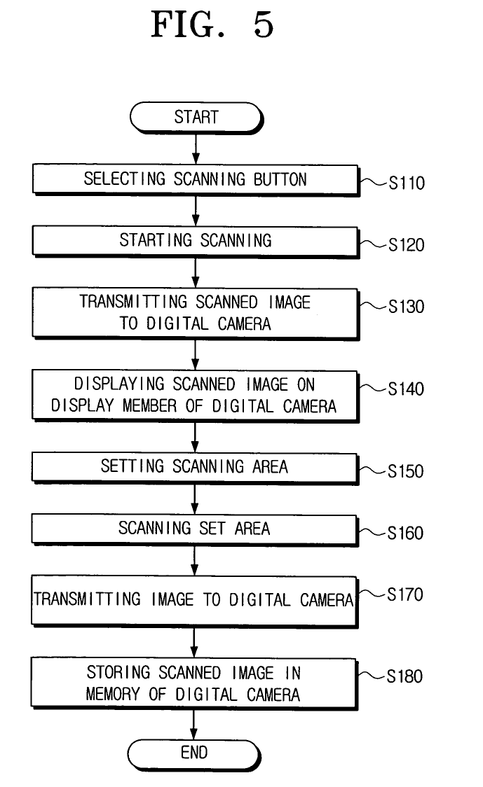

Hereinafter, an image scanning and storage method using the above described system will be explained in detail with reference to FIGS. 3 to 5.

For performing a scanning process, an image scanning apparatus 10 is connected to a digital camera 20 through a USB cable 30. An object to be scanned is placed on a holder. In step S110, a scanning button on one face of the image scanning apparatus 10 is selected. A control unit 15 drives a scanning module 12 to pre-scan the object in step S120. The light reflected from the object is converted into digital data while passing through the CCD image sensor and an image processing unit 13. The pre-scanned image is transmitted to the digital camera 20 through the USB cable 30 together with a command signal from the control unit 15 in step S130. A USB host controller 17 controls a USB device controller 27 of the digital camera 20 to transmit the command signal of the image scanning apparatus 10 to a control member 25 of the digital camera 20.

As shown in FIG. 3, when the command signal is transmitted from the control unit 15 to the control member 25 of the digital camera 20, the pre-scanned image is displayed on a display member 21 by the control member 25 in step S140. Then, in step S150, the area to be scanned is set while zooming in or out of the image using a zoom key 18 or moving the pre-scanned image displayed on the display member 21 into up, down, right and left directions using a direction key 19 in the image scanning apparatus 10. As a result, the area displayed on the display member 21 is set to be a scanning area.

A scanning area detection member 14 of the image scanning apparatus 10 detects the scanning area by detecting the operation of the zoom key 18 and the direction key 19. The control unit 15 operates the scanning module 12 to scan the area detected in the scanning area detection member 14 in step S160. After the area is scanned, the USB host controller 17 transmits the scanned image and the command signal of the control unit 15 to the USB device controller 27 of the digital camera 20 in step S170.

In step S180, the USB device controller 27 transmits the command signal from the image scanning apparatus 10 to the control member 25. The control member 25 stores the image that is transmitted from the image scanning apparatus 10 in the memory 23 in step S180.

When the image is stored in the memory 23, only the memory 23 is removed from the digital camera 20. The memory 23 is then connected to computers, etc to transmit the stored image to the computer.

According to the image scanning and storage system and the method using the same in accordance with an embodiment of the present invention, the image scanning apparatus 10 is connected to the digital camera 20 using the USB cable 30. The pre-scanned image is displayed on the display member 21 of the digital camera 20. The scanning area is set in the image displayed on the display member 21, and the image scanning apparatus scans the scanning area to transmit the image back to the digital camera 20. The image is then stored in the memory 23 of the digital camera 20.

Therefore, the scanning and storage process can be conducted without using computers. Since the scanning process is performed using the image scanning apparatus 10 and a simple peripheral device such as digital camera, the scanning process becomes convenient and simple. Moreover, an application program and an image scanning apparatus driver may not be needed, which is necessary for operating computers.

Instead of using the zoom key 18 and the direction key 19 installed in the image scanning apparatus 10, a zoom key and a direction key of the digital camera 20 may also be used to set the scanning area in the pre-scanned image displayed on the display member 21. In this case, however, the image scanning apparatus 10 cannot detect the scanning area. Hence, the digital camera 20 needs to be programmed to provide the information on the scanning area from the control member 25 to the image scanning apparatus 10.

Although a USB method for communicating the image scanning apparatus with the peripheral device such as the digital camera has been described in this embodiment, a RS-232C method may be employed. Additionally, a wireless communication method such as IrDA and Bluetooth can be used for communicating the image scanning apparatus with the peripheral device.

As described above, scanning and storage processes are performed without using computers according to embodiments of the present invention. Thus, the scanning process is conveniently performed. Moreover, an application program and an image scanning apparatus driver are not operated, which is necessary for operating the computers.

The foregoing embodiment and advantages are merely exemplary and are not to be construed as limiting the present invention. Also, the description of the embodiments of the present invention is intended to be illustrative, and not to limit the scope of the claims, and many alternatives, modifications, and variations should be apparent to those skilled in the art.

1. An image scanning and storage system comprising:
an image scanning apparatus including a scanning unit, a host controller and a control unit, the scanning unit scans an object in order to digitize an image of the object, the host controller communicates with a medium, the control unit controls the scanning unit and the host controller to transmit the image scanned in the scanning unit to the medium through the host controller;
a peripheral device, connected to the image scanning apparatus, including a display member, a memory, a device controller and a control member, the display member displays the image, the memory storing the image, the device controller communicates with the host controller, the control member displays the image pre-scanned in the image scanning apparatus on the display member and stores the scanned image in the memory according to a command signal of the control unit provided through the device controller; and
means for setting a scanning area in the pre-scanned image displayed on the display member, the means for setting being installed either in the image scanning apparatus or in the peripheral device.

2. The system as claimed in claim 1, wherein the peripheral device comprises a digital camera, a personal digital assistant (PDA), a cellular phone or a digital camcorder.

3. The system as claimed in claim 1, wherein the memory corresponds to an external memory that is removable from the peripheral device.

4. The system as claimed in claim 1, wherein the means for setting comprises a zoom key and a direction key, the zoom key zooming in or zooming out of the image displayed on the display member, the direction key moving the image into up, down, right and left directions.

5. The system as claimed in claim 1, wherein the image scanning apparatus comprises at least one of a scanner, a multi-function unit, a digital copying machine, and a facsimile.

6. The system as claimed in claim 4, wherein the control member is programmed to provide the image scanning apparatus with information on the scanning area set by the zoom key and the direction key.

7. The system as claimed in claim 1, wherein communication is performed using wireless or wireline communication process including a Universal Serial Bus (USB), RS-232C, IrDA or Bluetooth interface.

8. A method of scanning and storing an image using an image scanning apparatus and a peripheral device connected to the image scanning apparatus through a communication port, the image scanning apparatus having a scanning unit for scanning the image, the peripheral device having a display member for displaying the image, the method of scanning and storing an image comprising:
scanning an image in the image scanning apparatus;
transmitting the scanned image to the peripheral device; and
storing the scanned image to the memory of the peripheral device.

9. A method of scanning and storing an image using an image scanning apparatus and a peripheral device connected to the image scanning apparatus through a communication port, the image scanning apparatus having a scanning unit for scanning the image, the peripheral device having a display member for displaying the image, the method of scanning and storing an image comprising:
pre-scanning the image in the image scanning apparatus;
primary transmitting the pre-scanned image to the peripheral device;
displaying the transmitted pre-scanned image on the display member of the peripheral device;
setting a scanning area in the pre-scanned image displayed on the display member;
scanning the set area in the image scanning apparatus;
secondary transmitting the scanned image to the peripheral device; and
storing the scanned image in a memory of the peripheral device.

10. The method as claimed in claim 8, wherein the transmitting is performed using a Universal Serial Bus (USB), RS-232C, IrDA or Bluetooth interface.

11. The method as claimed in claim 9, wherein the transmitting is performed using a Universal Serial Bus (USB), RS-232C, IrDA or Bluetooth interface.

12. The method as claimed in claim 9, wherein setting the scanning area comprises setting the scanning area using a zoom key and a direction key installed either in the image scanning apparatus or in the peripheral device, the zoom key zooming in or zooming out the image, the direction key moving the image into up, down, right and left directions.

13. The method as claimed in claim 9, further comprising transmitting information on the scanning area from the peripheral device to the image scanning apparatus after setting the scanning area when the zoom key and the direction key are installed in the peripheral device.

14. The method as claimed in claim 8, wherein the peripheral device comprises a digital camera, a personal digital assistant (PDA), a cellular phone or a digital camcorder.

15. The method as claimed in claim 9, wherein the peripheral device comprises a digital camera, a personal digital assistant (PDA), a cellular phone or a digital camcorder.

16. The method as claimed in claim 8, wherein the memory corresponds to an external memory that is removable from the peripheral device.

17. The method as claimed in claim 9, wherein the memory corresponds to an external memory that is removable from the peripheral device.

18. The method as claimed in claim 8, wherein the image scanning apparatus comprises at least one of a scanner, a multi-function unit, a digital copying machine and a facsimile.

19. The method as claimed in claim 9, wherein the image scanning apparatus comprises at least one of a scanner, a multi-function unit, a digital copying machine and a facsimile.
